(19) United States
(12) Patent Application Publication
(10) Pub. No.: US 2012/0160933 A1
(43) Pub. Date: Jun. 28, 2012

(54) STRUCTURING ASSEMBLY FOR AN EXHAUST NOZZLE

(75) Inventors: Guy Bernard Vauchel, Harfleur (FR); Eric Conete, Merignac (FR)

(73) Assignees: Snecma Propulsion Solide, Le Haillan (FR); Aircelle, Gonfreville L'orcher (FR)

(21) Appl. No.: 13/394,250

(22) PCT Filed: Aug. 31, 2010
(86) PCT No.: PCT/FR2010/051809

§ 371 Date: Mar. 5, 2012

(30) Foreign Application Priority Data
Sep. 4, 2009 (FR) 09/04208

(51) Int. Cl. F02K 1/44

(52) U.S. Cl. 239/265.11

(57) ABSTRACT

The invention relates to a structuring assembly (13) for an exhaust nozzle, including the following main elements: (a) an outer skin (22) including a non-acoustic portion (33); (b) an inner structuring skin (23); (c) an acoustic structure (21) including cells (27) having a cellular core, said acoustic structure being arranged between the outer skin (22) and the inner structuring skin (23), at least one of said main elements being made of a composite material, and the acoustic structure (21) being supported between the outer skin (22) and inner structuring skin (23) by linking means (31; 41) attached to the inner structuring skin (23) and to the non-acoustic portion (33) of the outer skin (22) so as to transfer the stresses onto the inner structuring skin (23) and the non-acoustic portion (33) of the outer skin (22). The invention also relates to an exhaust nozzle for a nacelle, comprising such a structuring assembly (13), as well as to a nacelle.

### TECHNICAL FIELD

The present invention relates to a structuring assembly for an exhaust nozzle.

The present invention also relates to an exhaust nozzle and a nacelle comprising one such structuring assembly.

### BRIEF DESCRIPTION OF RELATED ART

An airplane is propelled by one or more propulsion assemblies each comprising a turbojet engine housed in a tubular nacelle. Each propulsion assembly is attached to an aircraft by a pylon situated under a wing or at the fuselage.

A nacelle generally has a structure comprising an air inlet upstream of the engine and a middle section able to surround a fan of the turbojet engine, a downstream section generally housing thrust reverser means and able to surround the combustion chamber of the turbojet engine. They nacelle ends with an exhaust nozzle whereof the outlet is situated downstream of the turbojet engine.

The exhaust nozzle is usually made up of an external module, also called shared nozzle or primary nozzle, and an inner module, also called exhaust cone or central afterbody.

For noise reduction reasons, the opposite surfaces of these two modules comprise acoustic structuring elements capable of trapping the noise.

To that end, each structuring assembly comprises a so-called “solid” air-impermeable inner structuring skin, not in direct contact with the primary hot air flow coming from the turbojet engine, an outer skin, in contact with the hot air flow and having an acoustically treated portion that surrounds an acoustic structure. The acoustic treatment generally is composed of forming holes with a diameter smaller than 5 mm. The acoustic structure usually comprises a structuring layer with a cellular core (structure commonly called “honeycomb”).

At the exhaust outlet, the hot gases coming from the turbojet engine have a high temperature at least equal to approximately 500° C.

It is known to make the structuring assembly from materials withstanding such temperatures, such as titanium, steel, or a superalloy of the Inconel® type. To that end, the different parts of the structuring assembly are assembled by adhesion, welding, or brazing.

However, titanium is an expensive material. Furthermore, it does not make it possible to produce structuring elements without defects in placing the acoustic structures on the inner and outer skins. In fact, due to the manufacturing play of the inner skin, the outer skin, and the acoustic structure, local detachment phenomena are observed, which compromises the strength of the structuring assembly.

The superalloy of the Inconel® type has a high density, which is detrimental to the mass of the propulsion part of the aircraft.

Furthermore, in the structuring elements of the prior art, part of the forces passes on the acoustic structure and also on the acoustic part of the outer skin. However, due to the presence of acoustic holes, the acoustic parts are less able to resist the forces undergone by the structuring assembly.

### BRIEF SUMMARY

One aim of the present invention is therefore to provide a structuring assembly for an exhaust nozzle having savings in terms of mass, that is easy to produce, with good strength without making the acoustically treated parts, such as the outer skin and the acoustic structure, more fragile.

To that end, the present invention relates to a structuring assembly for an exhaust nozzle, including the following main elements:
a. an outer skin including an acoustic portion having acoustic holes and a non-acoustic portion,
b. an inner structuring skin not having acoustic holes,
c. an acoustic structure including cells having a cellular core and arranged between the outer skin and the inner structuring skin,

at least one of said main elements a, b and c being made of a composite material, and the acoustic structure being supported between the outer skin and the inner structuring skin by linking means attached to the inner structuring skin and to the non-acoustic portion of the outer skin so as to transfer the stresses onto the inner structuring skin and the non-acoustic portion of the outer skin.

The assembly according to the invention makes it possible to attach the acoustic structure between the two skins using linking means attached on the non-acoustic portion thereof without any detachment phenomenon.

Advantageously, the element according to the present invention makes it possible to provide a specific composition of the composite elements so as to facilitate the industrial manufacturing and the assembly of the acoustic structure between the inner and outer skins.

Furthermore, the assembly according to the invention makes it possible to use different materials, such as metals, alloys, and composites, having specific heat expansion coefficients without the structural strength of the panel being compromised.

Furthermore, the attachment of the different components of the assembly according to the invention is done on the non-acoustic portions of the outer and structuring inner skins so as to transfer the forces onto the inner structuring skin and the non-acoustic portion of the outer skin. As a result, little or no force is transferred in the acoustic zones of the outer skin and in the acoustic structure, which reinforces the structural strength of the assembly according to the invention.

According to other features of the invention, the inventive structure comprises one or more of the following optional features, considered alone or according to all possible combinations:
the linking means comprise two substantially flat ends capable of being attached on the inner structuring skin or on the outer skin;
the linking means are substantially U-shaped;
the linking means are substantially Z-shaped;
the inner structuring skin is attached on the outer skin using at least two linking means attached substantially one on top of the other;
the linking means each have one end gripping the protuberance of the skin mounted on the acoustic structure;
the assembly according to the invention comprises additional linking means mounted on the inner structuring skin or on the non-acoustic portion of the outer skin;
the inner structuring skin comprises an opening making it possible to receive fastening means able to attach the linking means on the inner structuring skin;
the inner structuring and/or outer skin is monolithic;
the inner structuring and/or outer skin is made up of a multitude of portions substantially attached by linking means;
the linking means are substantially Z-shaped;
the inner structuring skin and the outer skin have substantially non-parallel surfaces;
the outer skin has a different thickness between the acoustic portion comprising the acoustic holes and the non-acoustic portion intended to receive the linking means;
the thickness of the acoustic structure is smaller than the height of the linking means;
the interface of the linking means has an overthickness at the substantially flat ends;
the outer skin and the inner structuring skin have two protuberances able to be attached to one another;
the acoustic structure has, at an upstream end, a portion having more significant play than the rest of the acoustic structure;
the composite material withstands a temperature at least equal to approximately 500° C.;
the composite material is a ceramic matrix composite material;
the surface of the attachment means mounted on the outer skin or the downstream end of the outer skin, said surface being intended to come into contact with the inner structuring skin, is substantially parallel to the surface of the inner structuring skin intended to receive the attachment means or the outer skin.

According to a second aspect, the present invention relates to an exhaust nozzle for a nacelle comprising a structuring assembly according to the invention.

Preferably, one of the two skins is made in a single piece and the structure formed by the acoustic structure mounted on the other skin is made up of a multitude of parts able to be attached to one another.

Preferably, one of the two skins is made from a multitude of portions that can be attached to one another, and the structure formed by the acoustic structure mounted on the other skin is a single piece.

According to another aspect, the present invention relates to a nacelle comprising an exhaust nozzle according to the invention.

### BRIEF DESCRIPTION OF RELATED ART

The invention will be better understood upon reading the following non-limiting description, done in reference to the appended figures.

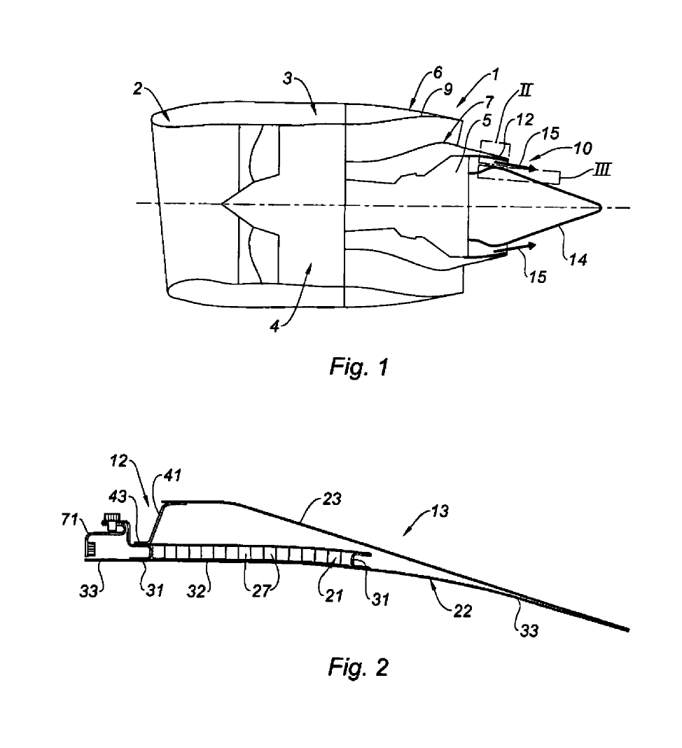

FIG. 1 is a longitudinal cross-section of a nacelle according to the invention;

FIG. 2 is an enlargement of zone II of the longitudinal cross-section of the inventive assembly of the external module of FIG. 1;

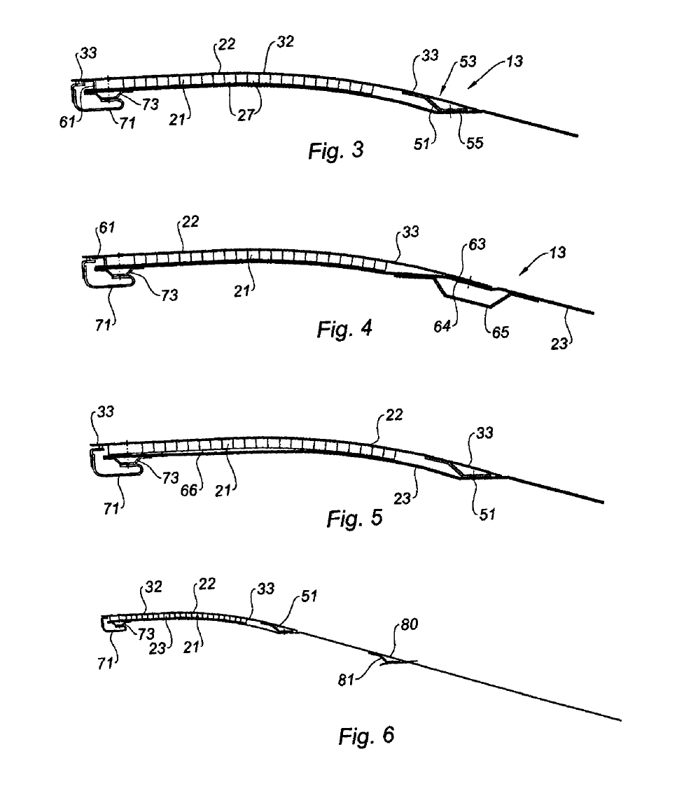

FIG. 3 is an enlargement of zone III of the longitudinal cross-section of the inventive assembly of the internal module of FIG. 1;

FIGS. 4 to 8 are alternatives of the embodiment of FIG. 3;

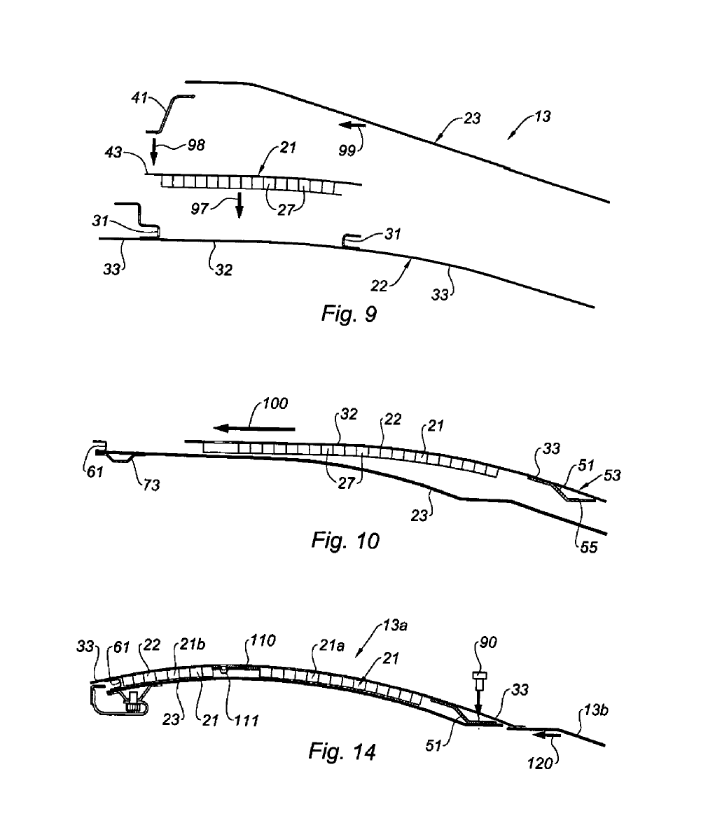

FIG. 9 is a longitudinal cross-section of the assembly of FIG. 2 during the phase for assembling the outer skin, the inner structuring skin, and the acoustic structure;

FIG. 10 is a longitudinal cross-section of the assembly of FIG. 3 during the phase for assembling the outer skin, the inner structuring skin, and the acoustic structure;

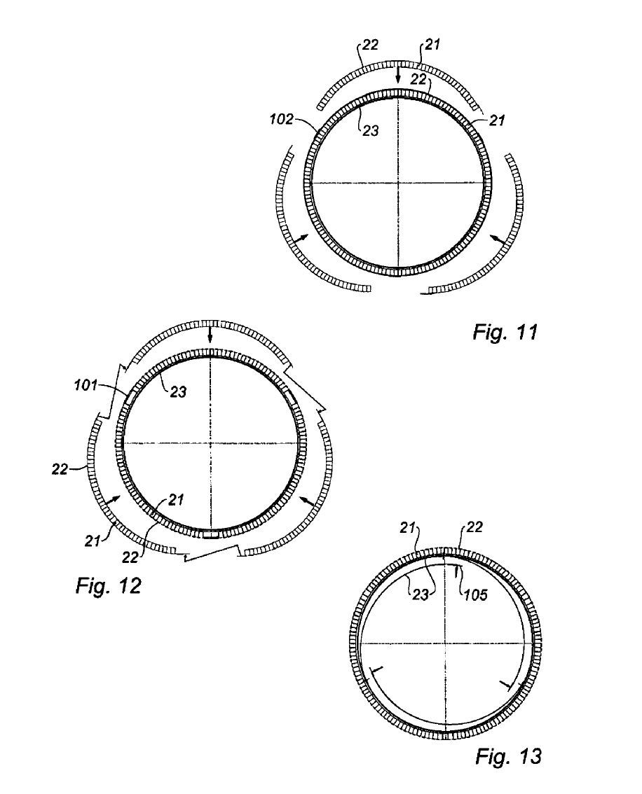

FIG. 11 is a transverse cross-section of one embodiment of the external module of the inventive nacelle during the placement phase and the assembly phase;

FIGS. 12 and 13 are transverse cross-sections of different embodiments of the internal module of the inventive nacelle during the placement phase and the assembly phase;

FIG. 14 is a longitudinal cross-section of one alternative of an embodiment of the internal module.

### DETAILED DESCRIPTION

As shown in FIG. 1, a nacelle 1 according to the invention comprises an air intake with 2, a middle structure 3 surrounding a fan 4 of the turbojet engine 5, and a downstream assembly 6. The downstream assembly 6 comprises an inner fixed structure 7 (IFS) surrounding the upstream portion of the turbojet engine 5, an outer fixed structure (OFS) (not shown), and a mobile cowl 9 comprising thrust reverser means. A suspension pylon (not shown) supports the turbojet engine 5 and the nacelle 1 according to the invention.

The nacelle 1 according to the invention ends with an exhaust nozzle 10 comprising an outer module 12 and an inner module 14. The inner 14 and outer 12 modules define a flow channel for the so-called hot primary air flow 15 leaving the turbojet engine 5.

As illustrated in FIGS. 2 to 10, the inner 14 and outer 12 modules comprise a structuring assembly 13 for an exhaust nozzle 10 comprising the following main elements:
an outer skin 22 in contact with the primary hot air flow 15 coming from the turbojet engine 5, said skin 22 including an acoustic portion 32 comprising acoustic holes and a non-acoustic portion 33,
an inner structuring skin 23 not in contact with said hot air flow 15, said skin 23 not comprising any acoustic holes,
an acoustic structure 21 including cells with a cellular core 27, said structure 21 being positioned between the outer skin 22 and the inner structuring skin 23.

The outer skin 22 has a surface opposite the acoustic structure 21 partially or totally pierced with acoustic holes. The positioning of the acoustic holes is done following an arrangement defined as a function of the desired sound attenuation. To that end, the acoustic surface of said skin 22 may for example be pierced using a laser or a mechanical piercer. Without being limited thereto, the acoustic holes typically have a diameter comprised between 0.2 mm and 3 mm, or between 0.8 mm and 1.6 mm.

The inner structuring skin 23 does not have any acoustic holes.

The inner structuring 23 and/or outer 22 skin is typically monolithic, i.e. made up of a plurality of plies of superimposed and polymerized composite.

The inner structuring skin 23, the outer skin 22 and/or the acoustic structure 21 of the inventive assembly are made from a composite material. According to one preferred embodiment, the composite material withstands a temperature at least equal to approximately 500° C., or more. The composite material is advantageously a ceramic matrix composite material, made up of geometric shapes having the advantage of being easy to produce and made from a light material withstanding the aforementioned temperatures.

In the event a primary element a, b or c of the inventive assembly 13, i.e. the inner structuring skin 23, the outer skin 22, or the acoustic structure 21, is not made from a composite material, it may be made from a metal material such as titanium or Inconel®.

In the case of an external module, as shown in FIG. 2, the acoustic structure 21 is supported between the outer skin 22 and the inner structuring skin 23 by linking means 31, 41 attached to the inner structuring skin 23 and the non-acoustic portion 33 of the outer skin 22 so as to transfer the forces onto the inner structuring skin 23 and the non-acoustic portion 33 of the outer skin 22 not comprising acoustic holes. A non-acoustic portion corresponds to a zone in which no acoustic treatment has been done, in particular no acoustic holes have been pierced (see FIG. 2). Typically, at least two linking means 31 are mounted on either side of the acoustic structure 21.

The attachment done mechanically by the linking means makes it possible to avoid the detachment of the various main elements a, b and c.

Furthermore, the linking means 31, 41 being mounted outside the cells with cellular cores of the acoustic structure 21, the forces are transferred very little or not at all onto the acoustic portions of the outer skin 22 and the acoustic structure 21. As a result, the inventive assembly 13 has very good mechanical resistance to forces.

The linking means 31, 41 can be attached on the inner 23 and outer 22 skins. The attachment of the connecting means 31, 41 on the outer 22 and inner 23 skins can be done using any means known by those skilled in the art, in particular by rivets.

In one alternative, the ends of the connecting means 31 are incorporated into one of the outer 22 or inner 23 skins.

The linking means 31, 41 can comprise two substantially flat ends, one of which is able to be attached on the inner structuring skin 23 or on the outer skin 22.

To that end, the linking means may be substantially in the shape of a U 31 or a Z 41.

At least one, in particular two linking means 31 are attached to the surface of the structuring portion 33 of the outer skin, forming the contact interface with the supported acoustic structure 21. To that end, in this embodiment, the linking means 31 are substantially U-shaped.

The inner structuring skin 23 can be attached on the outer skin 22 using at least two linking means 31, 41 attached substantially one on top of the other, at an upstream end of the acoustic structure. Thus, according to the embodiment of FIG. 2, the linking means 31, 41 each have one opposite end able to grip the protuberance 43 of the skin mounted on the acoustic structure 21. According to another embodiment, the linking means 41 can be attached directly on the outer skin 22.

Thus, the second linking means 41 can be attached substantially with the first substantially U-shaped linking means 31. In that case, the second linking means 41 are substantially Z-shaped. The shape of these connecting means 41 advantageously makes it possible to react the expansion gaps due to the internal and external temperature difference of the inner 14 and outer 12 modules.

Furthermore, the linking means 31 and 41, aside from the linking means, constitute reinforcing means able to mechanically reinforce the non-acoustic portions 33 of the inner 23 and outer 22 skins.

In the case where the module is an inner module, as shown in FIG. 3, a substantially Z-shaped linking means 51 and a substantially U-shaped linking means 61 can be mounted between the inner 23 and outer 22 skins. Typically, the two types of linking means 51 and 61 are each mounted at an upstream or downstream end of the acoustic structure 21. In that case, the downstream portion 53 has a so-called “cylindrical” shape, i.e. the linking means 51 previously mounted on the outer skin 22 and the inner structuring skin 23 have substantially parallel opposite surfaces. A cylindrical contact shape advantageously makes it possible to simplify the assembly.

The outer skin 22 can have a different thickness between the acoustic portion 32 comprising the acoustic holes and the structuring portion 33 intended to receive the linking means 51, 61 and not acoustically treated so as to strengthen the mechanical resistance of the non-acoustic portion 33. Thus, the thickness of the acoustic portion 32 comprising the acoustic holes is smaller than that of the structuring portion 33 intended to receive the linking means 51, 61 and not acoustically treated.

It is possible for the acoustic structure 21 not to be a single piece, but to be made up of a plurality of structures. In that case, at least two acoustic structures are positioned between the linking means 51, 61.

The thickness of the acoustic structure 21 can be smaller than the height of the linking means 51, 61 so as not to create contacts between the acoustic structure 21 and a structuring skin 22 or 23. Thus, in the case of an internal module 14, the acoustic structure 21 is positioned so as not to be in contact with the inner structuring skin 23 (see FIGS. 3 and 4). The spacing between the inner structuring skin 23 and the acoustic structure 21 is then close to a parallel to the aerodynamic line, or if the acoustic structure 21 has non-acoustic cellular cells with a configuration not parallel to the aerodynamic line, the wall of the inner structuring skin 23 can very closely follow a parallel to the bottom of the surface generated by the inside of the acoustic cellular cells 27.

The interface of the two outer 22 and inner 23 panels is said to be “ruled,” i.e. with a geometry close to a parallel to the axis of the nacelle 1 according to the invention.

As shown in FIG. 3, the interface of the substantially Z-shaped linking means 51 has an overthickness at the substantially flat ends. This overthickness is reacted by machining so as to make the interface with the inner structuring skin 23 compatible. In this way, the mounting of the assembly 13 according to the invention is made easier.

In the embodiment illustrated in FIG. 4, the outer skin 22 and the inner structuring skin 23 can have, at one end, two protuberances 63 and 64 able to be fastened to one another so as to reduce any gaps in producing the shape. In this case, there are no linking means and the interface is made skin on skin.

The assembly according to the invention can also comprise additional linking means 65 mounted on the inner structuring skin 23 at the junction area formed by the contact of the protuberances 63 and 64. These additional reinforcing means 65 can be mounted overlapping on the junction of two skins 22 and 23, making it possible to increase the mechanical strength of that junction. These additional linking means 65 can also be substantially L- or Z-shaped.

In one alternative illustrated in FIG. 5, the acoustic structure 21 can have, at an upstream end, a portion having more significant play 66 than the rest of the acoustic structure 21 so as to improve the installation reliability during placement of the acoustic structure 21 on the inner structuring skin 23. This play remains compatible with the expected performance of the acoustic structure 21 while allowing more space to perform an easy assembly of the acoustic structure 21 on the inner structuring skin 23.

As shown in FIG. 5, structuring attachment means 71 can be attached to the upstream end of the inner structuring skin 23 and/or the outer skin 22 so as to attach the outer 12 or inner 14 module on the turbojet engine 5. Said attachment means 71 can assume any adapted shape known by those skilled in the art. The attachment means 71 can be attached on one or several reinforcing means 73 attached on the inner structuring skin 23 or the outer skin 22 so as to transfer the forces toward the non-acoustic portions of the inventive assembly, i.e. the non-acoustic portion 33 of the outer skin and the inner structuring skin 23, without passing, or passing only in a very limited manner, through the acoustic structure 21 or through the acoustic portion 32 of the outer skin.

The inner structuring skin 23 can be made in several portions so as to simplify manufacturing (see FIG. 6). To that end, the interface 80 between two inner structuring skin portions 23 can be made either in a conical shape or a cylindrical shape. In the case of a cylindrical shape, linking means 81 can advantageously be used to attach the two portions to one another, in particular substantially Z-shaped linking means 81 (see FIG. 6).

It may be advantageous not to have attachment means on the outer surface of the inner structuring skin 23. In that case, the attachment means are attached by the inside on the mounting interface on the turbojet engine 5.

To access that zone, an upstream portion and at least one portion of the inner module are separated and attached.

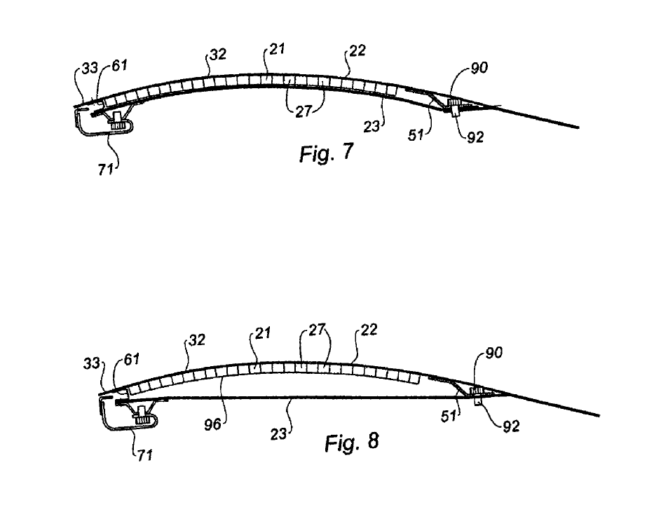

As shown in FIGS. 7 and 8, the inner structuring skin 23 or the outer skin 22 comprises an opening 90 making it possible to receive attachment means 92 able to attach the linking means 51 on the inner structuring skin 23.

The attachment means 92 can in particular be screws.

The mounting of the upstream portion on the turbojet engine 5 is thus done through the inside of the nacelle 1 according to the invention.

As shown in FIG. 8, the inner structuring skin 23 and the outer skin 22 can have substantially non-parallel surfaces. In fact, the upstream portion of the outer module can have a substantially curved geometric shape, i.e. only being able to be installed on a single side of the inner structuring skin 23 comprising a surface parallel to the surface formed by the outer skin 22.

In that case, the non-structuring skin 96 is mounted on the acoustic structure 21 on the surface opposite the inner structuring skin 23 so as not to deteriorate the acoustic capacity of the acoustic structure 21.

The inner structuring skin 23 can comprise two conical contact interfaces, one upstream and one downstream of the acoustic structure 21 (see FIG. 8).

In this way, it is possible to manufacture the above two elements in only two parts, one for the acoustic portion and one for the supporting structure, while allowing placement on the inner skin 23 by a single side of the acoustic structure 21 and by eliminating any relief or bump in the supporting portion.

The upstream interface between the acoustic structure 21 and the inner skin 23 has a different radius from that of the downstream interface, or higher (see FIG. 8), which allows a damage-free installation. In this way, it is advantageously possible to have only two substantially opposite portions to install.

Regarding the assembly of the inventive assembly in the case of an external module 12 as shown in FIG. 9, linking means 31 are attached on the outer skin 22 intended to grip the acoustic structure 21, then the acoustic structure 21 is assembled on the outer skin 22 (arrow 97) so as to have, at one of its upstream and downstream ends, said linking means 31. A second attachment means 41 grips the protuberance 43 of said acoustic structure 21 (arrow 98). The inner structuring skin 23 is then attached on the assembly thus formed at the linking means 41 (arrow 99).

In an inner module 14 as shown in FIG. 10, linking means 61 are attached on the inner structuring skin 23 and the outer skin 22 topped by the acoustic structure 21 is slid relative to the inner skin 23 (arrow 100). To that end, linking means 51 are mounted, in particular adhered, on the outer skin 22, then possibly machined so as to better adapt to the surface of the inner structuring skin 23.

Furthermore, one of the two inner 23 or outer 22 skins can be made in a single piece, i.e. in one portion. In that case, the structure formed from the acoustic structure 21 mounted on the other inner structuring skin 23 or outer skin 22 can be made up of a multitude of portions capable of being attached to one another.

In the case of an outer module as shown in FIG. 11, the inner structuring skin 23 is a single piece and the acoustic structure 21 attached on the outer skin 22 is made up of a multitude of portions comprising ends 101 and 102 capable of being attached to one another, in particular by overlapping.

According to another alternative, one of the two inner 23 or outer 22 skins is made from a multitude of portions capable of being attached to one another and the structure formed by the acoustic structure 21 mounted on the other outer skin 22 or inner structuring skin 23 is a single piece.

In particular in the case of an inner module as shown in FIGS. 12 and 13, the acoustic structure 21 attached on the outer skin 22 is a single piece and the inner structuring skin 23 is made up of a multitude of portions having ends 105 capable of being attached to one another.

The attachment of the portions can in particular be done by two protuberances able to overlap either by crossing (see FIG. 12) or directly (see FIG. 13). The attachment is for example done by rivets.

Advantageously, the interfaces between the different portions may not have any acoustic treatment so as not to impact the acoustic effectiveness of the assembly 13 according to the invention.

In the case of an inner module and as illustrated in FIG. 14, the acoustic structure 21 mounted on one of the two outer 22 or inner 23 skins being formed from a multitude of portions 21a and 21b, the latter parts can be attached via a protuberance 110 belonging to the portions that must be attached to one another. The interface thus formed can then receive attachment means, such as a rivet 111.

Furthermore, the assembly 13a according to the invention can be attached to a second assembly 13b at a ruled contact surface, for example, by sliding said second assembly 13b on the first assembly 13a (arrow 120).

1. A structuring assembly for an exhaust nozzle, comprising:
a. an outer skin including an acoustic portion having acoustic holes and a non-acoustic portion,
b. an inner structuring skin not having acoustic holes,
c. an acoustic structure including cells having a cellular core and arranged between the outer skin and the inner structuring skin,
at least one of said main elements being made of a composite material, and the acoustic structure being supported between the outer skin and the inner structuring skin by linking means attached to the inner structuring skin and to the non-acoustic portion of the outer skin so as to transfer stresses onto the inner structuring skin and the non-acoustic portion of the outer skin.

2. The assembly according to claim 1, wherein the linking means comprise two substantially flat ends capable of being attached on the inner structuring skin or on the outer skin.

3. The assembly according to claim 1, wherein the linking means are substantially U-shaped.

4. The assembly according to claim 2, wherein the linking means are substantially Z-shaped.

5. The assembly according to claim 1, wherein the inner structuring skin is attached on the outer skin using at least two linking means attached substantially one on top of the other.

6. The assembly according to claim 1, wherein the linking means each have one end gripping the protuberance of the skin mounted on the acoustic structure.

7. The assembly according to claim 1, comprising additional linking means mounted on the inner structuring skin or on the non-acoustic portion of the outer skin.

8. The assembly according to claim 1, wherein the inner structuring skin comprises an opening configured to receive fastening means able to attach the linking means on the inner structuring skin.

9. The assembly according to claim 1, wherein the inner structuring and/or outer skin is monolithic.

10. The assembly according to claim 1, wherein the inner structuring and/or outer skin is made up of a multitude of portions substantially attached by linking means.

11. The assembly according to claim 10, wherein the linking means are substantially Z-shaped.

12. The assembly according to claim 1, wherein the inner structuring skin and the outer skin have substantially non-parallel surfaces.

13. The assembly according to claim 1, wherein the outer skin has a different thickness between the acoustic portion comprising the acoustic holes and the non-acoustic portion intended to receive the linking means.

14. The assembly according to claim 1, wherein a thickness of the acoustic structure is smaller than a height of the linking means.

15. The assembly according to claim 1, wherein an interface of the linking means has an overthickness at the substantially flat ends.

16. The assembly according to claim 1, wherein the outer skin and the inner structuring skin have two protuberances able to be attached to one another.

17. The assembly according to claim 1, wherein the acoustic structure has, at an upstream end, a portion having more significant play than a remainder of the acoustic structure.

18. The assembly according to claim 1, wherein the composite material withstands a temperature at least equal to approximately 500° C.

19. The assembly according to claim 18, characterized in that the composite material is a ceramic matrix composite material.

20. The assembly according to claim 1, wherein a surface of the linking means mounted on the outer skin or the downstream end of the outer skin, said surface being intended to come into contact with the inner structuring skin, is substantially parallel to the surface of the inner structuring skin intended to receive the linking means or the outer skin.

21. An exhaust nozzle for a nacelle comprising a structuring assembly according to claim 1.

22. The nozzle according to claim 21, wherein one of the two skins is made in a single piece and the structure formed by the acoustic structure mounted on the other skin is made up of a multitude of parts able to be attached to one another.

23. The nozzle according to claim 21, wherein one of the two skins is made from a multitude of portions that can be attached to one another, and the structure formed by the acoustic structure mounted on the other skin is a single piece.

24. A nacelle comprising an exhaust nozzle according claim 21.
